(19) United States
(12) Patent Application Publication
(10) Pub. No.: US 2004/0044513 A1
(43) Pub. Date: Mar. 4, 2004

(54) Distributed simulation system

(76) Inventor: Noriaki Kitahara, Machida-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/630,786

(22) Filed: Jul. 31, 2003

(30) Foreign Application Priority Data
Sep. 2, 2002 (JP) 2002-256926

(51) Int. Cl. G06F 17/50

(52) U.S. Cl. 703/17

(57) ABSTRACT

A distributed simulation system of this invention performs simulation by use of a common facility where event-driven application programs loaded into a plurality of computers with a display unit connected to one another via a network assure information transfer between a plurality of objects existing in a distributed environment. The distributed simulation system comprises an user interface unit configured to receive an operation corresponding to the user's will, and an event notifying unit configured to notify the application programs of the user's operation given via the user interface unit as an event.

### CROSS-REFERENCE TO RELATED APPLICATIONS

This application is based upon and claims the benefit of priority from the prior Japanese Patent Application No. 2002-256926, filed Sep. 2, 2002, the entire contents of which are incorporated herein by reference.

### BACKGROUND OF THE INVENTION

1. Field of the Invention

This invention relates to a distributed simulation system. More particularly, this invention relates to a distributed simulation system in which a plurality of objects existing in a distributed environment exchange information via a common facility, such as RTI (Run-Time Infrastructure).

2. Description of the Related Art

In recent years, there has been an increasing demand for simulation systems in various fields. With this backdrop, HLA (High Level Architecture) has been determined. The purpose of HLA is to enhance the reutilization and the mutual management of simulation systems developed in the past to decrease the future development and maintenance costs.

HLA is the specification for connecting different simulation systems. HLA includes rules, object model templates (OMT), and interface specifications as elements. Of these elements, the interface specifications are implemented on the basis of RTI. A simulation object complying with interface specifications connectable to RTI is called a federate. A set of federates, or the whole simulation, is called a federation.

Forming a simulation system under such a framework makes it possible not only to make good use of the legacy works developed in the past but also to construct a large-scale system in a distributed environment, which is a considerable merit.

In the existing system of this type, simulation is carried out under predetermined initial conditions. That is, once simulation is started, there is no room for the user's will to intervene in the simulation. In a word, the result is merely obtained according to a prepared scenario. Therefore, the provision of a simulation system capable of being carried out in line with reality has been desired.

### BRIEF SUMMARY OF THE INVENTION

It is, accordingly, an object of the present invention to provide a distributed simulation system which enables the user's will to intervene in the operation of a simulation during its execution and thereby realizes an environment closer to reality.

The forgoing object is accomplished by providing a distributed simulation system comprising a plurality of computers each including a display unit, the computers being connected to one another via a network and loaded with event-driven application programs, respectively, and the programs each executing simulation by use of a common facility assuring an information transfer between a plurality of objects existing in a distributed environment, the distributed simulation system comprising an interface unit configured to interface with respect to a user by receiving an operation corresponding to the user's will and an notifying unit. The notifying unit notifies the application programs of the user's operation given via the user interface unit as an event.

In particular, the distributed simulation system further comprises an display control unit configured to display on the display unit a symbol acting as an interface for receiving an operation corresponding to the user's will. The interface unit accepts the user's operation making use of the symbol displayed on the display unit.

Use of such means provides the user with a GUI (Graphical User Interface) environment. Then, for example, the user's will given through the GUI is notified as an event to the application programs. Since the application programs realizing the simulation are of the event-driven type, the notifying of the user's will as an event to the application programs enables the user's will to intervene in the simulation even when the simulation is being carried out. This makes it possible to provide a distributed simulation system capable of realizing an environment closer to reality.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 is a conceptual diagram showing the configuration of a federation according to an embodiment of the present invention;

FIG. 2 is a block diagram of a distributed simulation system which realizes the federation of FIG. 1;

FIG. 3 shows an example of the federation realized by the system of FIG. 2;

FIG. 4 is a conceptual diagram of an example of the contents displayed on the display section 12 of FIG. 2 when the federation is in progress; and

FIG. 5 shows another example of the federation realized by the system of FIG. 2.

### DETAILED DESCRIPTION OF THE INVENTION

Hereinafter, referring to the accompanying drawings, an embodiment of the present invention will be explained in detail. In the embodiment, suppose a strategic process of friends attacking enemies or vice versa is simulated. This type of simulation can be applied to an ambush simulation where a threatening enemy plane is intercepted. Hereinafter, the simulation carried out in the embodiment is referred to as a federation.

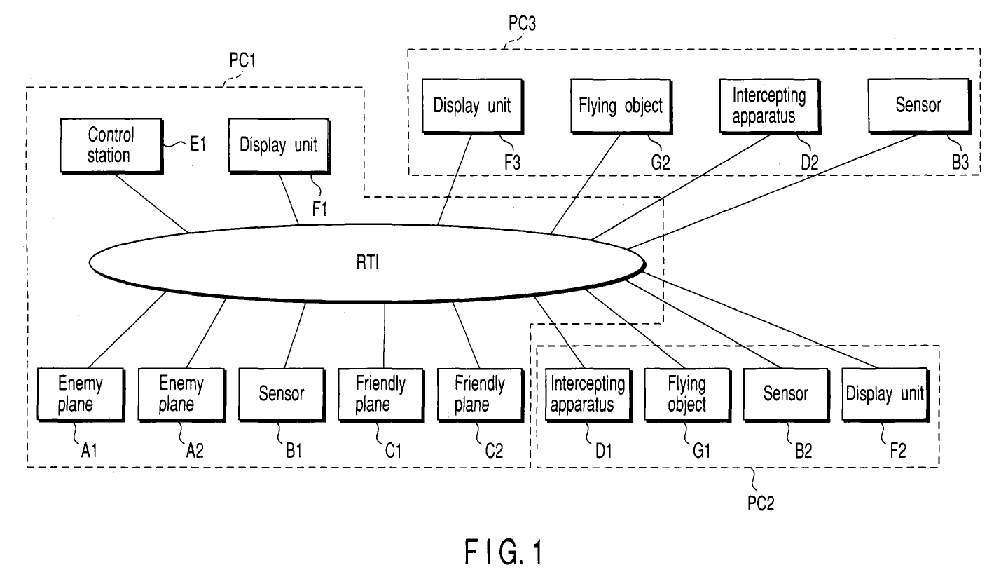

FIG. 1 is a conceptual diagram showing the configuration of a federation according to the embodiment. In this confederation, enemy planes A1, A2, friendly planes C1, C2, sensors B1, B2, B3, intercepting apparatuses D1, D2, and a control station E1 are simulation models. Moreover, other objects joining the federation include flying objects G1, G2, and display units F1, F2, F3.

Each of the enemy planes A1, A2, friendly planes C1, C2, flying objects G1, G2, sensors B1 to B3, intercepting apparatuses D1, D2, control station E1, and display units F1 to F3 has an interface specification connectable to RTI. That is, these objects are realized as federates joining in the federation. Each federate determines its behavior semi-automatically on the basis of the information acquired through RTI. Of the objects, the RTI, enemy planes A1, A2, friendly planes C1, C2, sensor B1, control station E1, and display unit F1 are assumed to be installed in a computer CP1. The intercepting apparatus D1, sensor B2, and display unit F2 are assumed to be installed in a computer PC2. The intercepting apparatus D2, sensor B3, and display unit F3 are assumed to be installed in a computer PC3. The flying objects G1, G2 can be considered to be objects created at, for example, PC2 and PC3 in intercepting enemy planes.

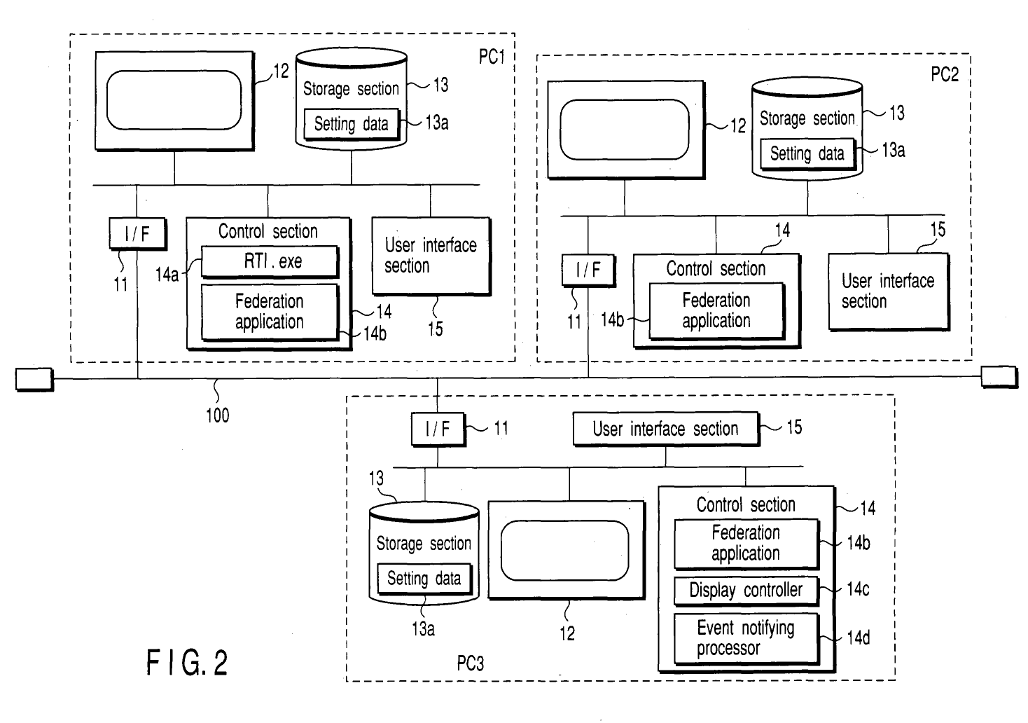

FIG. 2 is a block diagram of a distributed simulation system which realizes the federation of FIG. 1. The system has a plurality of computers PC1 to PC3 connected to one another via a communication line 100.

Each of the computers PC1 to PC3 includes an interface section (I/F) 11, a display section 1, a storage section 13, a control section 14, and an user interface section 15. The interface section (I/F) 11 interfaces with another computer via the communication line 100 to exchange information. The storage section 13 stores various setting data 13a about the implementation of the federation into a specific storage area. The user interface section 15, which has a keyboard or a mouse (not shown), accepts the user's operation through GUI on the display section 12.

The control section 14 of PC1 includes a RTI.exe file 14a and a federation application 14b. The RTI.exe file 14a is a control program for causing the control section 14 to operate as an executing entity for providing an RTI environment. The federation application 14b is an event-driven control program for realizing a federation according to various specifications requested by the user. These programs are loaded from the storage section 13 into the internal memory (not shown) of the control section 14 and then executed. The federation application 14b is also provided in the control section 14 of each of the other computers PC2 and PC3.

The federation application 14b in each of the computers PC1 to PC3 executes the call, create, delete, and other processes to objects, thereby realizing a federation. These processes are carried out by the PC1 to PC3 exchanging information via the communication line 100.

The control section 14 of PC3 includes a display controller 14c and an event notifying processor 14d. The display controller 14c displays clickable symbols on the display section 12 as interfaces to accept the operation according to the user's will. The symbols include operation buttons and selectable icons.

The event notifying processor 14d informs the federation application 14b of the user's operation given via the user interface section 15 as an event. The user's operation includes clicking an icon on the display section 12 with the mouse. Since the federation application 14b is of the event-driven type, the user's operation is reflected in the contents of the process. The result of the process at the federation application 14b is reflected in the contents displayed on the display section 12.

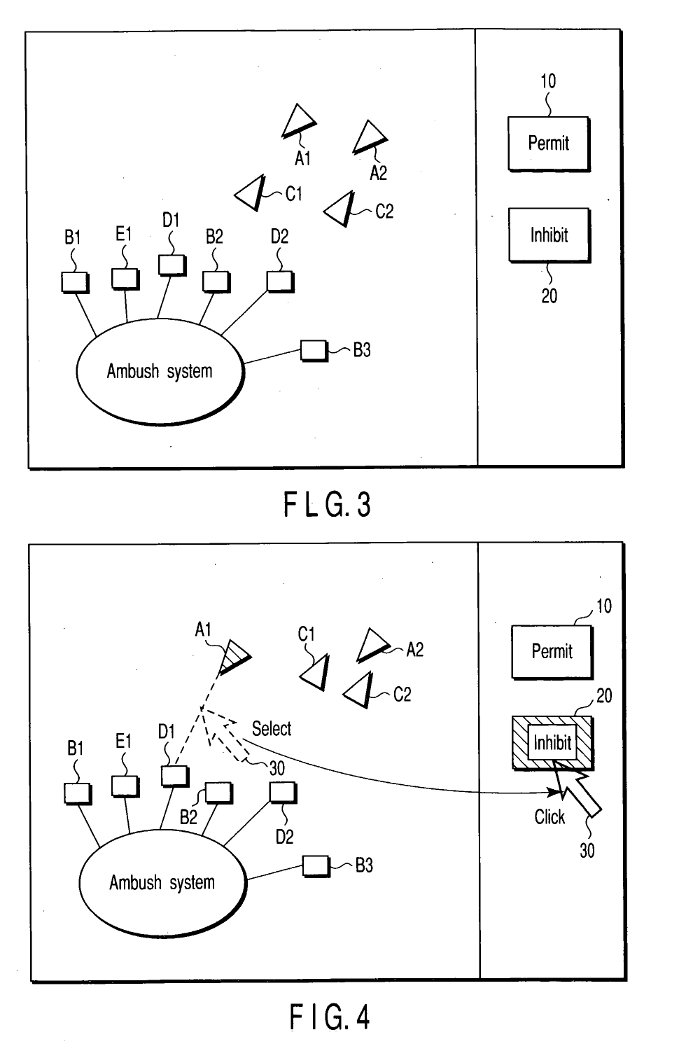

FIG. 3 shows an example of the federation realized by the system of FIG. 2. In FIG. 3, an example of the contents displayed on the display section 12 of each of the computers PC1 to PC3 is shown. The display section 12 displays an ambush system, the enemy planes A1, A2 threatening the ambush system, and the friendly planes C1, C2 fighting against the threat, assumed in the federation of the embodiment. The ambush system is a distributed firing control system including sensors B1 to B3 and intercepting apparatuses D1, D2. These objects are each created as the federation progresses.

The embodiment is characterized in that a clickable permit button 10 and a clickable inhibit button 20 are displayed on the display section 12 of, for example, the computer PC3.

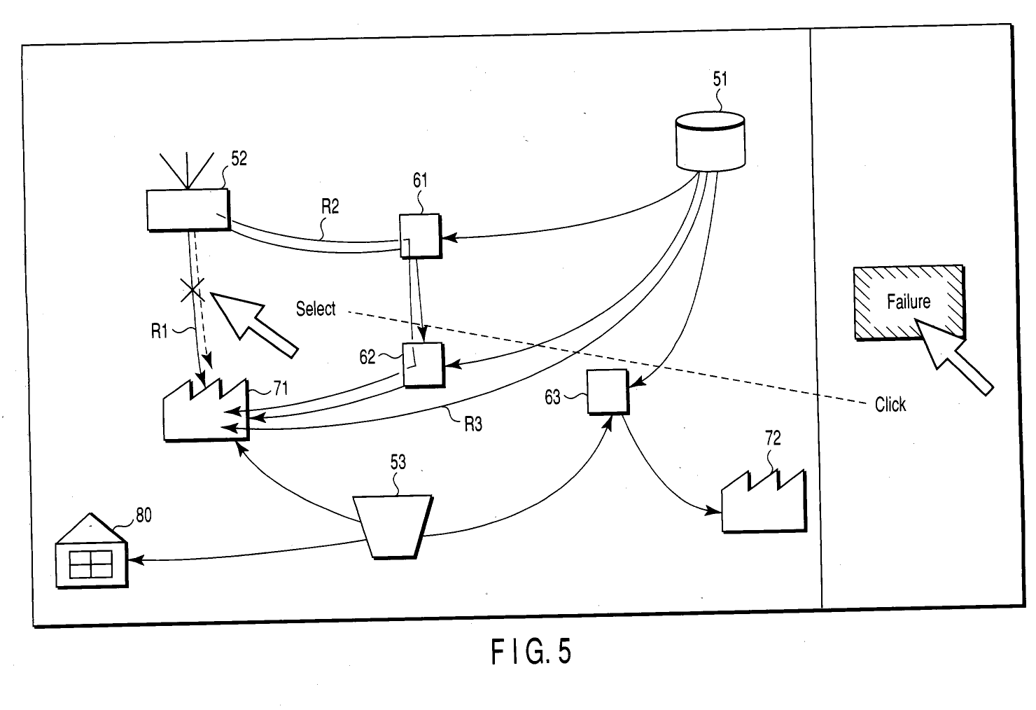

FIG. 4 is a conceptual diagram of an example of the contents displayed on the display section 12 during the progress of the federation. In FIG. 4, each federate operates on the basis of its own semi-automated judgment as the federation progresses. The enemy planes A1, A2 calculate the positional relationship with and the distance to the sensors B1 to B3, intercepting apparatuses D1, D2, and friendly planes C1, C2 at intervals of, for example, 0.1 second. The sensors B1 to B3 calculate the positional relationship between the enemy planes A1, A2 and the friendly planes C1, C2.

When any enemy plane approaches any intercepting apparatus and the distance between them decreases below a specific threshold value, a clickable line 40 connecting the intercepting apparatus and the enemy plane is drawn on the screen (by a dotted line in the figure). FIG. 4 shows a state where the enemy plane A1 has approached the intercepting apparatus D1.

Watching the screen, the user (or the user of computer PC3) selects the line 40 by clicking the line with the mouse pointer 30. Then, the user specifies his or her will as to whether to permit the intercepting apparatus D1 to intercept the enemy plane A1. The specifying operation is performed by clicking the permit button 10 or the inhibit button 20. FIG. 4 shows that the inhibit button 20 has been clicked. Once the inhibit button 20 has been clicked, even if how much the enemy plane A1 approaches the range of the intercepting apparatus D1, the intercepting apparatus D1 will never launch the flying object G1.

The result of the user's operation is reflected in the contents displayed on the display section 12 of another computer. That is, when the inhibit button 20 is clicked on PC3, the inhibit button 20 is highlighted on the display section 12 of PC3. Then, on each of computers PC1, PC2, too, the inhibit button 20 is highlighted. In the computers PC1, PC2, each of the buttons 10, 20 is set so as not to respond to clicking.

In a conventional system, such a scenario as goes “If an enemy plane enters the range of the intercepting apparatus, launch a flying object” is prepared in advance. The federation is implemented according to the scenario. The scenario is prepared by setting the shooting range for each intercepting apparatus and recording the contents in the setting data 13a. Therefore, in the existing system, there is no room for the user's will to intervene during the progress of the federation.

In contrast, with the embodiment, the federation application 14b for realizing the federation is provided under the event-driven architecture. The federation application 14b is loaded into the control section 14 of each of the computers PC1 to PC3 and then operates. The display controller 14c provides a GUI environment for accepting the operation corresponding to the user's will. Then, the event notifying processor 14d notifies the federation application 14b of the contents of the user's operation by use of the user interface section 15 as an event. According to this notification, the result of the processing at the federation application 14b is reflected in the contents displayed on the display section 12.

Accordingly, the contents of the user's operation are reflected in the progress of the federation. Thus, it is possible to cause the simulation to progress, while securing a room for the user's judgment to intervene in the progress.

This invention is not limited to the above embodiment.

FIG. 5 is a diagram showing another example of the federation realized by the system of FIG. 2. FIG. 5 shows a system which simulates a power supply route in a certain region. In FIG. 5, an example of the contents shown on the display section 12 of each of the computers PC1 to PC3 at the time of the execution of the simulation is shown.

In FIG. 5, it is assumed that power stations 51 to 53 supply electric power to factories 71, 72 and a house 80. The power stations 51 to 53, factories 71, 72, house 80, and repeaters 61, 62 act as federates. The initial setting values in this type of simulation include, for example, the upper limit of supply in each supply route of electric power.

In FIG. 5, it is assumed that when there is no failure in the system, the factory 71 receives the power supply from the power station 52 via a route R1. In this state, when the user selects the route R1 and clicks the “Failure” button on the screen, the occurrence of a failure in the route R1 is notified to the simulation system. In response to this, each federate determines its own behavior on the basis of the initial condition. As a result, a new power supplying route R2 is created. FIG. 5 shows a case where a route R2 extending from the power station 52 to the factory 71 by way of the repeaters 61, 62.

To simulate a case where the power station 52 is down, the user selects the power station 52 and clicks the “Failure” button. In this case, for example, a supplying route R3 extending from the power station 51 to the factory 71 by way of the repeater 62 will be created. To realize such a simulation, a distributed simulation related to the present invention can be applied.

Furthermore, this invention may be applied to a case where measures against an emergency in each power station are simulated by using such objects as water-supply paths and control rods constituting a nuclear power plant as federates. In addition, the invention may be applied to the simulation of plane operation, train operation, or vehicle operation.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A distributed simulation system comprising a plurality of computers each including a display unit, the computers being connected to one another via a network and loaded with event-driven application programs, respectively, and the programs each executing simulation by use of a common facility assuring an information transfer between a plurality of objects existing in a distributed environment, the distributed simulation system comprising:
an interface unit configured to interface with respect to a user by receiving an operation corresponding to the user's will; and
a notifying unit configured to notify the application programs of the operation received via the interface unit as an event.

2. The distributed simulation system according to claim 1, further comprising
a display control unit configured to display on the display unit a symbol acting as an interface for receiving an operation corresponding to the user's will, wherein
the interface unit accepts the user's operation making use of the symbol displayed on the display unit.

3. The distributed simulation system according to claim 2, wherein the display control unit reflects the result of the notifying of the event to the application programs in the contents displayed on the display units of said plurality of computers.

4. The distributed simulation system according to any one of claim 1, wherein the simulation is realized under RTI (Run-time Infrastructure) for executing each service determined in HLA (High Level Architecture) interface specifications.

5. The distributed simulation system according to claim 4, wherein the simulation is realized as a federation which includes, as federates, a plurality of nodes and a plurality of links connecting these nodes to form a network.

6. The distributed simulation system according to claim 5, wherein
said plurality of nodes include power stations generating electric power and receivers who receive the electric power,
said plurality of links are power lines for supplying the electric power from the power station to the receiver, and
the federation is a simulation which simulates a route for supplying electric power from the power stations to the receivers via the power line.

7. The distributed simulation system according to claim 6, wherein the federation further includes elements constituting the power stations as the federates.
